(19) United States
(12) Patent Application Publication
(10) Pub. No.: US 2025/0112401 A1
(43) Pub. Date: Apr. 3, 2025

(54) ELECTRICAL CONNECTOR HAVING A SHIELD

(71) Applicant: Lear Corporation, Southfield, MI (US)

(72) Inventors: Angel Molinero Benitez, Valls (ES); Antoni Pujol Simon, Valls (ES)

(73) Assignee: Lear Corporation, Southfield, MI (US)

(21) Appl. No.: 18/376,110

(22) Filed: Oct. 3, 2023

(51) Int. Cl. H01R 13/52

(52) U.S. Cl. CPC H01R 13/52

(57) ABSTRACT

Electrical connectors are described. An example electrical connector has an electrical conductor and a housing. The housing is attached to the electrical conductor and has a first end, a second end, a top, a bottom, a first side, a second side, and a shield. The first side extends from the first end to the second end. The second side extends from the first end to the second end. The shield extends from the first side, away from the second side, and away from the top. The shield has a shield first side, a shield second side, a shield first end, and a shield second end. The shield first side extends from the shield first end to the shield second end and along the first side of the housing. The shield second side defines a terminal side of the shield.

### SUMMARY

Various example electrical connectors that have a shield are described.

An example electrical connector has an electrical conductor and a housing. The housing is attached to the electrical conductor and has a first end, a second end, a top, a bottom, a first side, a second side, and a shield. The first side extends from the first end to the second end. The second side extends from the first end to the second end. The shield extends from the first side, away from the second side, and away from the top. The shield has a shield first side, a shield second side, a shield first end, and a shield second end. The shield first side extends from the shield first end to the shield second end and along the first side of the housing. The shield second side defines a terminal side of the shield.

Additional understanding of these examples can be obtained by review of the detailed description, below, and the appended drawings.

### BRIEF DESCRIPTION OF THE DRAWINGS

FIG. 1 is a perspective view of a first example of an electrical connector that has a shield.

FIG. 2 is another perspective view of the electrical connector illustrated in FIG. 1.

FIG. 3 is a front view of the electrical connector illustrated in FIG. 1.

FIG. 4 is a rear view of the electrical connector illustrated in FIG. 1.

FIG. 5 is a right side view of the electrical connector illustrated in FIG. 1.

FIG. 6 is a left side view of the electrical connector illustrated in FIG. 1.

FIG. 7 is a top view of the electrical connector illustrated in FIG. 1.

FIG. 8 is a bottom view of the electrical connector illustrated in FIG. 1.

FIG. 9 is a sectional view of the electrical connector illustrated in FIG. 7 taken along line 9-9.

FIG. 10 is a partial sectional view of the electrical connector illustrated in FIG. 1 and a grounding member.

FIG. 11 is a top view of a second example electrical connector that has a shield.

FIG. 12 is a top view of a third example electrical connector that has a shield.

FIG. 13 is a side view of a fourth example electrical connector that has a shield.

FIG. 14 is a side view of a fifth example electrical connector that has a shield.

### DETAILED DESCRIPTION

The following detailed description and the appended drawings describe and illustrate various example embodiments of electrical connectors that have a shield. The description and illustration of these examples are provided to enable one skilled in the art to make and use an electrical connector that has a shield according to this invention. They are not intended to limit the scope of the claims in any manner. The invention is capable of being practiced or carried out in various ways and the examples described and illustrated herein are merely selected examples of the various ways of practicing or carrying out the invention and are not considered exhaustive.

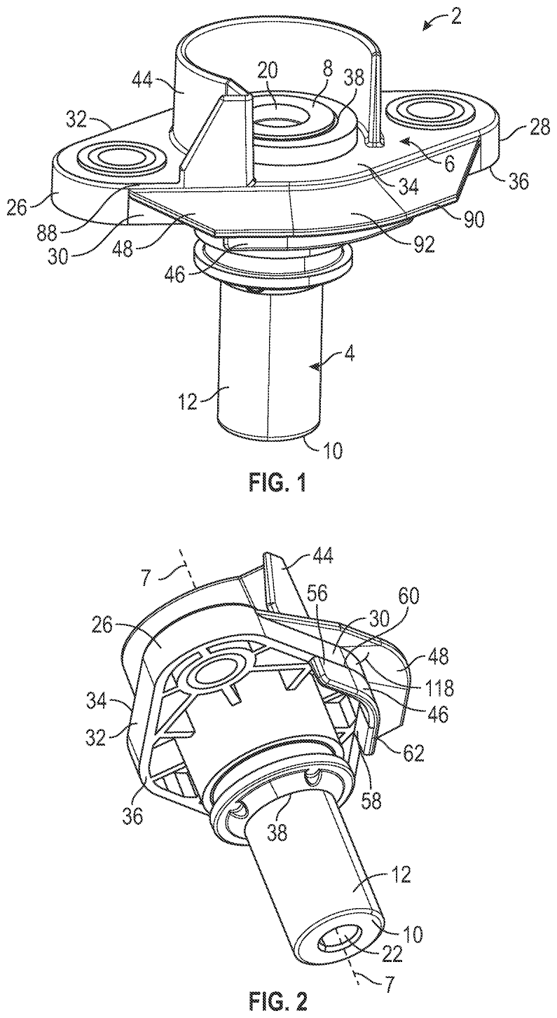

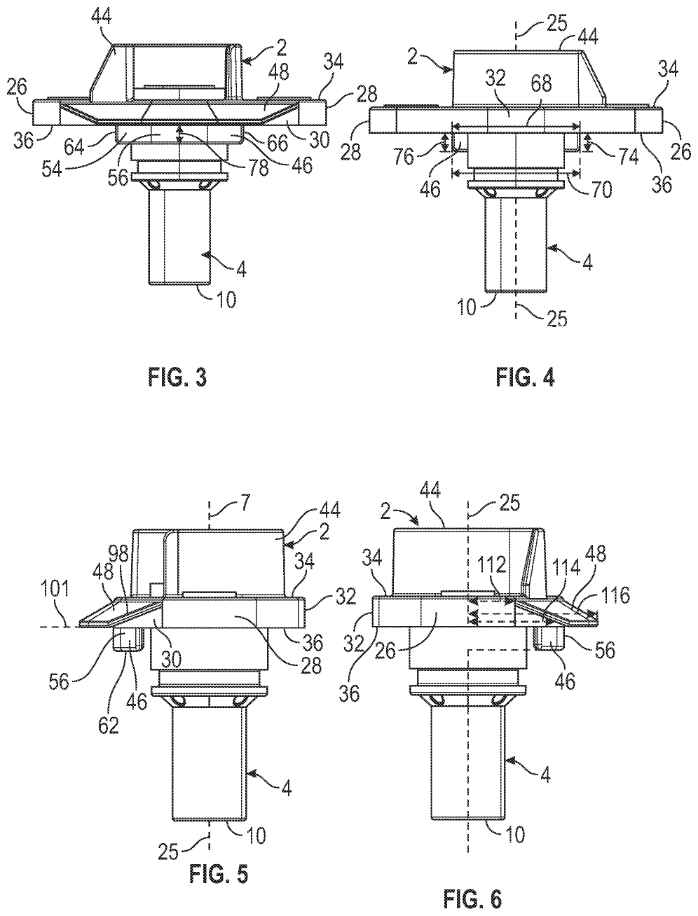

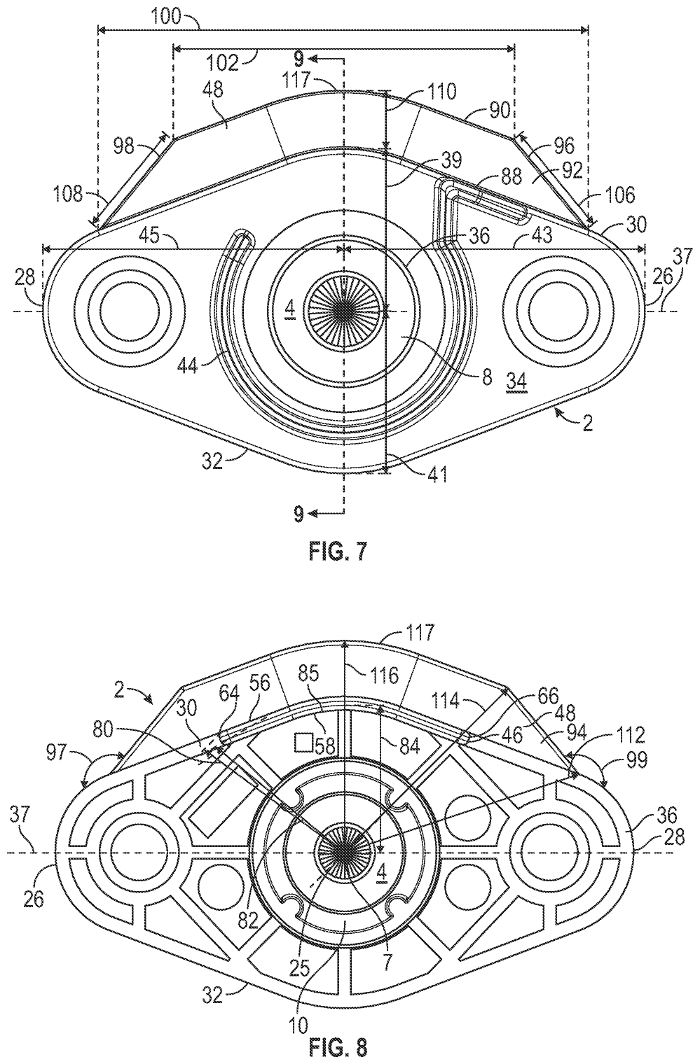

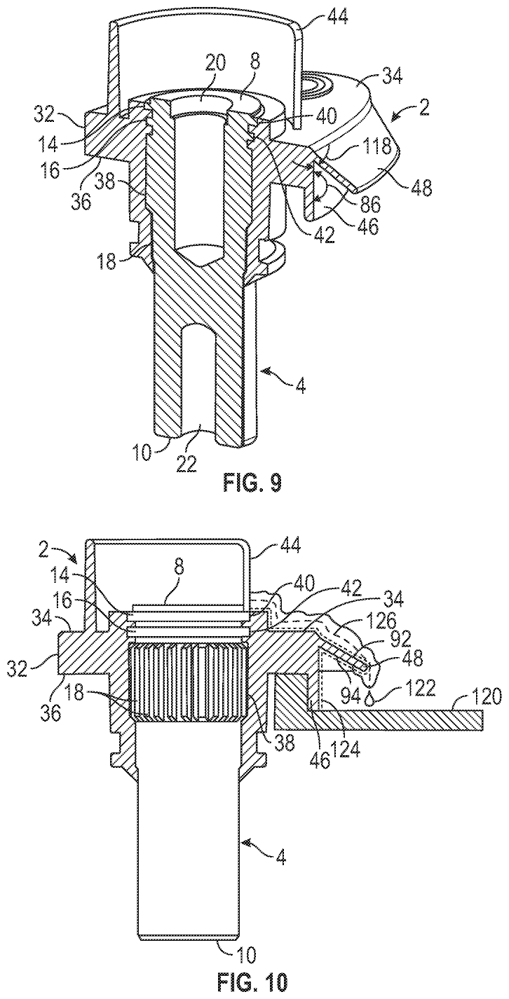

FIGS. 1 through 10 illustrate a first example of an electrical connector 2 that has an electrical conductor 4 and a housing 6.

The electrical conductor 4 has a central axis 7, an electrical conductor top 8, an electrical conductor bottom 10, an electrical conductor main body 12 that defines a first projection 14, a second projection 16, a plurality of teeth 18, a first recess 20, and a second recess 22. Each of the first and second projections 14, 16 extends radially outward from the electrical conductor main body 12 and is disposed between the plurality of teeth 18 and the electrical conductor top 8. Each tooth of the plurality of teeth 18 extends radially outward from the electrical conductor main body 12 and is disposed between the second projection 16 and the electrical conductor bottom 10. The first recess 20 extends from the electrical conductor top 8 toward the electrical conductor bottom 10. The second recess 22 extends from the electrical conductor bottom 10 toward the electrical conductor top 8. The central axis 7 extends from the electrical conductor top 8 to the electrical conductor bottom 10, through the center of the first recess 20, and through the center of the second recess 22. The central axis 7 intersects the lengthwise axis 37 of the housing 6, as described in more detail herein. The electrical conductor 4 serves as a conduit for electrical current.

While the electrical conductor 4 has been illustrated as having a particular structural arrangement, an electrical conductor included in an electrical connector can have any suitable structural arrangement. Selection of a suitable structural arrangement for an electrical conductor included in an electrical connector can be based on various considerations, such as the type of component to which the electrical connector is being attached. For example, an electrical conductor can include a single through passage that extends from an electrical conductor top to an electrical conductor bottom. Alternatively, an electrical conductor can be omitted from an electrical connector.

An electrical conductor can be formed of any suitable material and selection of a suitable material can be based on various considerations, such as the intended use of an electrical connector of which an electrical conductor is a component. Examples of materials considered suitable to form an electrical conductor include electrically conductive materials, and any other material considered suitable for a particular embodiment.

The housing 6 is attached to the electrical conductor 4 and has a central axis 25, a first end 26, a second end 28, a first side 30, a second side 32, a top 34, a bottom 36, a lengthwise axis 37, a passageway 38, a first recess 40, a second recess 42, a projection 44, a flange 46, and a shield 48. The housing 6 is partially disposed over the electrical conductor 4. The first end 26 and the second end 28 opposably face one another. The first side 30 and the second side 32 opposably face one another. The top 34 and the bottom 36 opposably face one another. The lengthwise axis 37 extends from the first end 26 to the second end 28 and intersects the central axis 7. The central axis 25 is disposed in the passageway 38 at an angle relative to the lengthwise axis 37. In the embodiment illustrated in FIGS. 1 through 10, the central axis 25 is disposed orthogonally to the lengthwise axis 37, is disposed between the first end 26 and the second end 28, and is coaxial with central axis 7 of the electrical conductor 4. The central axis 25 is disposed a first distance 39 from the first side 30, a second distance 41 from the second side 32, a third distance 43 from the first end 26, and a fourth distance 45 from the second end 28. In the illustrated embodiment, the first distance 39 and the second distance 41 are equal to one another and the third distance 43 and the fourth distance 45 are equal to one another. However, in alternative embodiments, a first distance and a second distance can be different and/or a third distance and a fourth distance can be different.

The passageway 38 extends from the top 34 to the bottom 36. The electrical conductor 4 is disposed within the passageway 38. Each of the first recess 40 and the second recess 42 extends from the passageway 38 and into the housing 6. The first recess 40 is sized and configured to receive the first projection 14 of the electrical conductor 4 and the second recess 42 is sized and configured to receive the second projection 16 of the electrical conductor 4. The mating configuration between the first recess 40 and the first projection 14 and the mating configuration between the second recess 42 and the second projection 16 provide a mechanism for releasably attaching the housing 6 to the electrical conductor 4. The plurality of teeth 18 are disposed within the passageway 38 and contact the housing 6 to prevent rotational movement of the housing 6 relative to the electrical conductor 4.

The projection 44 extends from the top 34 of the housing 6 and away from the bottom 36 of the housing 6. In the embodiment shown, the projection 44 extends partially around the passageway 38 and provides structure for protecting the electrical conductor 4 from the elements during use or accomplishing a connection between the housing 6 and another electrical component (e.g., a second electrical connector). In the example illustrated in FIGS. 1 through 10, the projection 44 is disposed parallel to the central axis 25 of the housing 6. However, in alternative embodiments, a projection can have any suitable structural arrangement.

The flange 46 extends from the first side 24 of the housing 6 and has a flange main body 54, a flange first side 56, a flange second side 58, a flange top 60, a flange bottom 62, a flange first end 64, and a flange second end 66. The flange 46 provides structure for anchoring the electrical connector 2 to another component. The flange 46 extends along the bottom 36 of the housing 6 and away from the top 34 of the housing 6. The flange top 60 extends along the first side 24 of the housing 6. The flange bottom 62 is a terminal side of the flange 46. In the example illustrated in FIGS. 1 through 10, the flange 46 is disposed parallel to the central axis 25 of the housing 6. The flange first end 64 and the flange second end 66 opposably face one another. The flange first side 56 and the flange second side 58 opposably face one another.

The flange first side 56 has a flange first length 68 that extends from the flange first end 64 to the flange second end 66. The flange second side 58 has a flange second length 70 that extends from the flange first end 64 to the flange second end 66. In the example illustrated, the flange second length 70 is equal to the flange first length 68. However, in alternative embodiments, a flange first length and a flange second length can be different. The flange first end 64 has a flange first end length 74 that extends from the bottom 36 of the housing 6 to the flange bottom 62. The flange second end 66 has a flange second end length 76 that extends from the bottom 36 of the housing 6 to the flange bottom 62. In the example illustrated in FIGS. 1 through 10, the flange second end length 76 is equal to the flange first end length 74. However, in alternative embodiments, a flange second end length and a flange first end length can be different. The flange 46 has a flange third length 78 is disposed between the flange first end 64 and the flange second end 66. The flange third length 78 extends from the bottom 36 of the housing 6 to the flange bottom 62. In the illustrated embodiment, the flange third length 78 is equal to the flange first end length 74 and the flange second end length 76. However, in alternative embodiments, a flange third length can be greater than, less than, or different than a flange first end length and/or a flange second end length. The flange first side 56 at the flange first end 64 is disposed a flange first distance 80 from the central axis 25 of the housing 6. The flange second side 58 at the flange first end 64 is disposed a flange second distance 82 from the central axis 25 of the housing 6. The flange second side 58 between the flange first end 64 and the flange second end 66 is disposed a flange third distance 84 from the central axis 25 of the housing 6. In the embodiment shown, the flange first distance 80 and the flange second distance 82 are different and the flange third distance 84 is different than the flange first distance 80 and the flange second distance 82. The flange third distance 84 is less than the flange first distance 80 and the flange second distance 82 such that the flange defines a curve 85 between the flange first end 64 and the flange second end 66. The flange 46 is disposed at flange angle 86 relative to the first side 36 of the housing 6. In the illustrated embodiment, the flange angle 86 is equal to about 180 degrees. However, in alternative embodiments, a flange angle can be any suitable angle, such as angles between 90 degrees and 270 degrees, or any other angle considered suitable for a particular embodiment.

The shield 48 extends from the first side 24 of the housing 6 and has a shield first side 88, a shield second side 90, a shield top 92, a shield bottom 94, a shield first end 96, and a shield second end 98. The shield 48 extends along the first side 24 of the housing 6, away from the second side 32 of the housing 6, and away from the top 34 of the housing 6. The shield second side 90 defines a terminal side of the shield 48. The shield first end 96 and the shield second end 98 opposably face one another. The shield top 92 and the shield bottom 94 opposably face one another.

The shield first side 88 has a shield first length 100 that extends from the shield first end 96 to the shield second end 98. The shield second side 90 has a shield second length 102 that extends from the shield first end 96 to the shield second end 98. In the illustrated embodiment, the shield second length 102 is less than the shield first length 100. However, in alternative embodiments a shield second length can be equal to or greater than a shield first length. The shield first end 96 has a shield first end length 106 that extends from the shield first side 88 to the shield second side 90. The shield first end 96 is disposed at a first angle 97 relative to the first side 30 of the housing 6. The shield second end 98 has a shield second end length 108 that extends from the shield first side 88 to the shield second side 90 and is equal to the shield first end length 106. However, in alternative embodiments a shield second end length and a shield first end length can be different. The shield second side 90 is disposed at a second angle 99 relative to the first side 30 of the housing 6. Each of the first angle 97 and the second angle 99 are greater than 90 degrees. However, in alternative embodiments, a first angle and/or a second angle can be equal to, or less than, 90 degrees. As shown in FIG. 5, the shield second end 98 is disposed on a hypothetical plane 101 that is disposed between the top 34 of the housing 6 and the flange bottom 62 and is disposed orthogonally to the central axis 25 of the housing 6. In the illustrated embodiment, the hypothetical plane 101 contains the bottom 36 of the housing 6. However, in alternative embodiments, a shield second side can be disposed on any suitable number of hypothetical planes, some of which may include the entirety, or a portion, of a bottom of a housing. The shield 48 has a shield third length 110 disposed between the shield first end 96 and the shield second end 98 that extends from the shield first side 88 to the shield second side 90. In the example illustrated in FIGS. 1 through 10, the shield third length 110 is less than the shield first end length 106 and the shield second end length 108. However, in alternative embodiments, a shield third length can be equal to, or greater than, a shield first end length and/or a shield second end length.

The shield first side 88 at the shield first end 96 is disposed a shield first distance 112 from the central axis 25 of the housing 6. The shield second side 90 at the shield first end 96 is disposed a shield second distance 114 from the central axis 25 of the housing 6. The shield second side 90 between the shield first end 96 and the shield second end 98 is disposed a shield third distance 116 from the central axis 25 of the housing 6. In the embodiment shown, the shield first distance 112 and the shield second distance 114 are different from one another and the shield third distance 116 is different than the shield first distance 112 and the shield second distance 114. The shield third distance 116 is greater than the shield first distance 112 and the shield second distance 114 such that the shield 48 defines a curve 117 between the shield first end 96 and the shield second end 98.

The shield 48 is disposed at shield angle 118 relative to the first side 30 of the housing 6 that is that is less than 90 degrees. However, in alternative embodiments, a shield can be disposed at any suitable angle relative to a housing, such as angles equal to, greater than, or less than 90 degrees, between about 90 degrees and about 1 degree, and any other angle considered suitable for a particular embodiment. A housing 6 that includes a shield 48 disposed at a shield angle 118 that is less than 90 degrees prevents outside elements (e.g., rain, saltwater) from impacting the electrical connector 4 and the components to which the electrical connector 4 is intended to be attached.

While the housing 6 has been illustrated as having a particular structural arrangement, a housing included in an electrical connector can have any suitable structural arrangement. Selection of a suitable structural arrangement for a housing included in an electrical connector can be based on various considerations, such as the type of component to which the electrical connector is being attached. A housing can be formed of any suitable material and selection of a suitable material can be based on various considerations, such as the intended use of an electrical connector of which a housing is a component. Examples of materials considered suitable to form a housing include electrically nonconductive materials, plastics, and any other material considered suitable for a particular embodiment.

FIG. 10 illustrates the electrical connector 4 attached to a grounding member 120 (e.g., aluminum surface). As shown, the inclusion of a shield 48 on the housing 6 increases the total length of a first creepage path 124, which decreases galvanic corrosion during use. The first creepage path 124 represents the minimal distance running between the electrical conductor 4 and the grounding member 120 along the surface of the housing 6. The first creepage path 124 extends from the electrical conductor 4 along the top 34 of the housing 6, along the shield top 92, along the shield bottom 94, and along the flange 46. In addition to the first creepage path 124, FIG. 10 illustrates that the inclusion of a shield 48 results in a break in continuity (e.g., through drops 122) as a material 126 (e.g., rain, saltwater) travels over the shield 48, which also decreases galvanic corrosion during use. The structural features of the electrical connector 2, particularly the inclusion of the shield 48, result in an increased first creepage path 124, increased electrical resistance, and a break in continuity of a material traveling over the electrical connector 4 relative to previous electrical connectors.

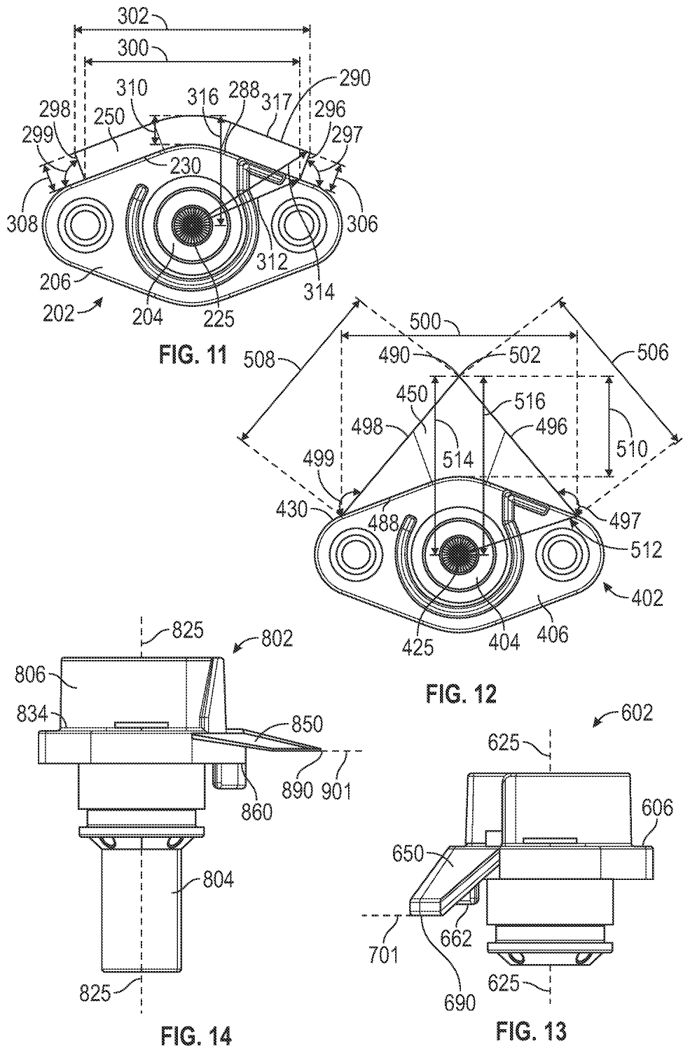

FIG. 11 illustrates a second example of an electrical connector 202 that has a shield 250. The electrical connector 202 is similar to the electrical connector 2 illustrated in FIGS. 1 through 10 and described above, except as detailed below. The electrical connector 202 has an electrical conductor 204 and a housing 206.

In the illustrated embodiment, the shield first side 288 has a shield first length 300 that extends from the shield first end 296 to the shield second end 298. The shield second side 290 has a shield second length 302 that extends from the shield first end 296 to the shield second end 298. In the illustrated embodiment, the shield second length 302 is greater than the shield first length 300. The shield first end 296 has a shield first end length 306 that extends from the shield first side 288 to the shield second side 290. The shield first end 296 is disposed at a first angle 297 relative to the first side 230 of the housing 206. The shield second end 298 has a shield second end length 308 that extends from the shield first side 288 to the shield second side 290 and is equal to the shield first end length 306. The shield second side 290 is disposed at a second angle 299 relative to the first side 230 of the housing 206. Each of the first angle 297 and the second angle 299 is equal to about 90 degrees. The first angle 297 and the second angle 299 are equal to one another. The shield 250 has a shield third length 310 disposed between the shield first end 296 and the shield second end 298 that extends from the shield first side 288 to the shield second side 290. In the example illustrated in FIG. 11, the shield third length 310 is equal to the shield first end length 306 and the shield second end length 308. The shield first side 288 at the shield first end 296 is disposed a shield first distance 312 from the central axis 225 of the housing 206. The shield second side 290 at the shield first end 296 is disposed a shield second distance 314 from the central axis 225 of the housing 206. The shield second side 290 between the shield first end 296 and the shield second end 298 is disposed a shield third distance 316 from the central axis 225 of the housing 206. In the embodiment shown, the shield first distance 312 and the shield second distance 314 are different from one another and the shield third distance 316 is different than the shield first distance 312 and the shield second distance 314. The shield third distance 316 is less than the shield first distance 312 and the shield second distance 314 such that the shield 250 defines a curve 317 between the shield first end 296 and the shield second end 298.

FIG. 12 illustrates a third example of an electrical connector 402 that has a shield 450. The electrical connector 402 is similar to the electrical connector 2 illustrated in FIGS. 1 through 10 and described above, except as detailed below. The electrical connector 402 has an electrical conductor 404 and a housing 406.

In the illustrated embodiment, the shield first side 488 has a shield first length 500 that extends from the shield first end 496 to the shield second end 498. The shield second side 490 defines a shield point 502. In the illustrated embodiment, the shield first length 500 is greater than the length at the shield point 502. The shield first end 496 has a shield first end length 506 that extends from the shield first side 488 to the shield second side 490. The shield first end 496 is disposed at a first angle 497 relative to the first side 430 of the housing 406. The shield second end 498 has a shield second end length 508 that extends from the shield first side 488 to the shield second side 490 and is equal to the shield first end length 506. The shield second side 490 is disposed at a second angle 499 relative to the first side 430 of the housing 406. Each of the first angle 497 and the second angle 499 is greater than 90 degrees. The first angle 497 and the second angle 499 are equal to one another. The shield 450 has a shield third length 510 disposed between the shield first end 496 and the shield second end 498 that extends from the shield first side 488 to the shield second side 490. In the example illustrated in FIG. 12, the shield third length 510 is greater than the shield first end length 506 and the shield second end length 508. The shield first side 488 at the shield first end 496 is disposed a shield first distance 512 from the central axis 425 of the housing 406. The shield second side 490 at the shield first end 496 is disposed a shield second distance 514 from the central axis 425 of the housing 406. The shield point 502 is disposed a shield third distance 516 from the central axis 425 of the housing 406. In the embodiment shown, the shield first distance 512 and the shield second distance 514 are different from one another and the shield third distance 516 is equal to the shield second distance 514. The shield third distance 516 is greater than the shield first distance 512.

FIG. 13 illustrates a fourth example of an electrical connector 602 that has a shield 650. The electrical connector 602 is similar to the electrical connector 2 illustrated in FIGS. 1 through 10 and described above, except as detailed below. The electrical connector 602 has a housing 606 and omits the inclusion of an electrical conductor.

In the illustrated embodiment, the shield second side 690 is disposed on a hypothetical plane 701 that is disposed below the flange bottom 662 and is disposed orthogonally to the central axis 625 of the housing 606.

FIG. 14 illustrates a fifth example of an electrical connector 802 that has a shield 850. The electrical connector 802 is similar to the electrical connector 2 illustrated in FIGS. 1 through 10 and described above, except as detailed below. The electrical connector 802 has an electrical conductor 804 and a housing 806.

In the illustrated embodiment, the shield second side 890 is disposed on a hypothetical plane 901 that is disposed between the flange top 860 and the top 834 of the housing 806 and is disposed orthogonally to the central axis 825 of the housing 806.

The illustration of any component, element, or feature as being disposed above, below, left of, or right of another component, element, or feature is only with reference to the relative location of the components, elements, and features as shown in the figures in order to aid in describing the electrical connectors. Accordingly, some of the components, elements, or features illustrated and described herein can be oriented in any manner desired without departing from the spirit or scope of the invention.

Those with ordinary skill in the art will appreciate that various modifications and alternatives for the described and illustrated embodiments can be developed in light of the overall teachings of the disclosure, and that the various elements and features of one example described and illustrated herein can be combined with various elements and features of another example without departing from the scope of the invention. Accordingly, the particular examples disclosed herein have been selected by the inventor(s) simply to describe and illustrate examples of the invention and are not intended to limit the scope of the invention or its protection, which is to be given the full breadth of the appended claims and any and all equivalents thereof.

What is claimed is:

1. An electrical connector comprising:
an electrical conductor; and
a housing attached to the electrical conductor, the housing having a first end, a second end, a top, a bottom, a first side, a second side, and a shield, the first side extending from the first end to the second end, the second side extending from the first end to the second end, the shield extending from the first side, away from the second side, and away from the top, the shield having a shield first side, a shield second side, a shield first end, and a shield second end, the shield first side extending from the shield first end to the shield second end and along the first side of the housing, the shield second side defining a terminal side of the shield;
wherein the shield is disposed at a shield angle relative to the first side of the housing that is less than 90 degrees.

2. The electrical connector of claim 1, wherein the housing has a lengthwise axis extending from the first end of the housing to the second end of the housing; and
wherein the housing has a passageway having a central axis that intersects the lengthwise axis.

3. The electrical connector of claim 2, wherein the central axis is disposed orthogonally to the lengthwise axis.

4. The electrical connector of claim 2, wherein the first side of the housing is disposed a first distance from the central axis; and
wherein the shield second side is disposed a second distance from the central axis that is different than the first distance.

5. The electrical connector of claim 4, wherein the second distance is greater than the first distance.

6. The electrical connector of claim 1, wherein the shield first side has a shield first length; and
wherein the shield second side has a shield second length that is different than the shield first length.

7. The electrical connector of claim 6, wherein the shield second length is less than the shield first length.

8. The electrical connector of claim 1, wherein the shield first end has a shield first end length; and
wherein the shield second end has a shield second end length that is equal to the shield first end length.

9. The electrical connector of claim 1, wherein the shield first end is disposed at an angle relative to the first side of the housing that is greater than 90 degrees.

10. The electrical connector of claim 9, wherein the shield second end is disposed at an angle relative to the first side of the housing that is greater than 90 degrees.

11. The electrical connector of claim 1, wherein the shield defines a curve between the shield first end and the shield second end.

12. The electrical connector of claim 1, wherein the shield second end is disposed on a hypothetical plane that contains the bottom of the housing.

13. The electrical connector of claim 1, wherein the housing has a flange extending from the first side of the housing and away from the top of the housing.

14. The electrical connector of claim 13, wherein the flange has a flange bottom; and
wherein the shield second end is disposed on a hypothetical plane disposed between the top of the housing and the flange bottom.

15. The electrical connector of claim 1, wherein the housing has a passageway; and
wherein the housing has a housing first recess and a housing second recess, each of the housing first recess and the housing second recess extending from the passageway and into the housing.

16. The electrical connector of claim 1, wherein the electrical conductor has an electrical conductor top, an electrical conductor bottom, and an electrical conductor main body that defines a first recess and a second recess, the first recess extending from the electrical conductor top toward the electrical conductor bottom, the second recess extending from the electrical conductor bottom toward the electrical conductor top.

17. The electrical connector of claim 1, wherein the electrical conductor is formed from an electrically conductive material.

18. The electrical connector of claim 17, wherein the housing is formed from an electrically nonconductive material.

19. An electrical connector comprising:
an electrical conductor;
a housing attached to the electrical conductor, the housing having a lengthwise axis, a first end, a second end, a top, a bottom, a first side, a second side, a passageway having a central axis that intersects the lengthwise axis, and a shield, the lengthwise axis extending from the first end to the second end, the first side extending from the first end to the second end, the first side disposed a first distance from the central axis, the second side extending from the first end to the second end; and
the shield extending from the first side, away from the second side, and away from the top, the shield having a shield first side, a shield second side, a shield first end, and a shield second end, the shield first side extending from the shield first end to the shield second end and along the first side of the housing, the shield first side having a shield first side length, the shield second side defining a terminal side of the shield and disposed a second distance from the central axis that is different than the first distance, the shield second side having a shield second side length that is different than the shield first side length;
wherein the shield is disposed at a shield angle relative to the first side of the housing that is less than 90 degrees.

20. An electrical connector comprising:
an electrical conductor;
a housing attached to the electrical conductor, the housing having a lengthwise axis, a first end, a second end, a top, a bottom, a first side, a second side, a passageway having a central axis that intersects the lengthwise axis, and a shield, the lengthwise axis extending from the first end to the second end, the first side extending from the first end to the second end, the first side disposed a first distance from the central axis, the second side extending from the first end to the second end; and
the shield extending from the first side, away from the second side, and away from the top, the shield having a shield first side, a shield second side, a shield first end, a shield second end, and defining a curve between the shield first end and the shield second end, the shield first side extending from the shield first end to the shield second end and along the first side of the housing, the shield first side having a shield first side length, the shield second side defining a terminal side of the shield and disposed a second distance from the central axis that is greater than the first distance, the shield second side having a shield second side length that is less than the shield first side length;
wherein the shield is disposed at a shield angle relative to the first side of the housing that is less than 90 degrees.
